(19) United States
(12) Patent Application Publication
(10) Pub. No.: US 2026/0211707 A1
(43) Pub. Date: Jul. 23, 2026

(54) INTELLIGENT DYNAMIC UPDATING OF USER INTERFACE/USER EXPERIENCE ("UI/UX") BASED ON CHANGES IN CLOUD CONATINERIZATION SETUP

(71) Applicant: Bank of America Corporation, Charlotte, NC (US)

(72) Inventor: Vinod Maghnani, Gurugram Haryana (IN)

(21) Appl. No.: 19/034,175

(22) Filed: Jan. 22, 2025

(51) Int. Cl. G06F 9/451

(52) U.S. Cl. CPC G06F 9/451

(57) ABSTRACT

Systems and methods for intelligent, dynamic updating of a user interface/user experience (“UI/UX”) based on changes in cloud containerization setup. The systems and methods may include a server. The server may include a plurality of cloud container applications. The systems and methods may include a user interface (“UI”). The UI may be operable to run the plurality of cloud container applications, a UI program, and a source application. The source application may include a model-viewer-controller (“MVC”) layer. The systems and methods may include a dynamic mapping control engine (“DMCE”). The systems and methods may include a machine learning (“ML”) engine. The ML engine may include an ML program. The systems and methods may scan, via the DMCE, the plurality of cloud container applications for a cloud containerization setup. The systems and methods may detect, via the ML program on the ML engine, an anomaly in the cloud containerization setup.

### FIELD OF TECHNOLOGY

Aspects of the disclosure relate to systems and methods for intelligent dynamic updating of user interface/user experience (“UI/UX”) based on changes in cloud containerization setup.

### BACKGROUND OF THE DISCLOSURE

One of the biggest challenges for UI and/or UX stability is continuous changes in cloud containerization setup. Continual changes to cloud container setups can ultimately lead to UI/UX instability. Currently, there is no control in place for a distributed cloud environment and maintaining UI/UX stability in the face of changes to a cloud containerization setup.

Therefore, there exists a need to develop an intelligent system and method capable of detecting, monitoring, and tracking changes to a container setup in a cloud environment. Accordingly, there is also a need to modify UI/UX at run-time.

### SUMMARY OF THE DISCLOSURE

Provided herein are systems and methods for intelligently identifying changes to a cloud container setup and modifying UI systems and programs in real-time. A cloud container setup is a portable environment for running cloud container applications in a cloud environment. Cloud container setups may package a cloud container application's code, libraries, and dependencies into a single setup that can be deployed and run consistently across different cloud environments, regardless of underlying infrastructure.

Systems and methods may include modifying a UI program with new connectors. New connectors are modules that may enable a UI to communicate with other microservices, application protocol interfaces (“APIs”), and/or external systems. New connectors may update cloud container applications to integrate additional services and/or components.

Systems and methods may include a UI. The UI may run a UI program. Systems and methods may include a dynamic mapping control engine (“DMCE”). A DMCE is an engine using dynamic mapping and engine control to optimize system performance and efficiency in real-time. Dynamic mapping uses real-time data acquisition and adaptive control strategies to optimize system and/or method performance and efficiency. Engine control includes, e.g., real-time data acquisition, adaptive modeling, and dynamic adjustment of DMCE parameters to optimize performance and efficiency.

The DMCE may detect and monitor changes to a cloud container application. The DMCE may continuously adjust UI and UI program parameters based on the changes to the cloud container application.

Systems and methods may include a machine learning (“ML”) program. The ML program may dynamically identify an anomaly in the cloud container setup. Anomalies may be any event or thing causing UI/UX instability. Examples of anomalies may include, e.g., unbalanced data/resource distribution, malware, unauthorized access, abnormal network traffic, unauthorized loadings, computer viruses, high call frequency, and attempted payload drops. Anomalies may be fixed and/or addressed by, e.g., resource adjustments, scaling, memory limit increases, automated remediations, policy-based resolutions, hierarchical resolutions, performance optimizations, security measures, and logging, monitoring, updating, and patching one or more UI programs.

The ML program may send feedback to the DMCE. Feedback may include anomaly characterizations, system performance metric evaluations, error control, model performance score analysis, updated features, updated UI program code, updated UI program parameters, and updated dynamic adjustment factors for the UI and/or the UI program.

The systems and methods may provide a DMCE operable to scan and monitor changes in cloud container applications and accordingly modify a UI program. The DMCE may modify the UI program with new connectors. The DMCE may modify the UI program by removing/altering changes in the cloud container applications that may cause UI/UX instability. The DMCE may modify the UI program by removing/altering changes in the cloud container applications via the new connectors. The systems and methods may provide an ML program operable to intelligently keep track of any anomalies in a cloud container setup.

The systems and methods may trace anomalies in the cloud container setup using a model-viewer-controller (“MVC”) layer of a source application. An MVC layer is an architectural design pattern separating the source application's logic into three interconnected components: a model, a view, and a controller. The model includes the data and logic/algorithms of the source application. The view presents information to the user in visual/audio format via the UI, based on the model. The controller acts as an intermediary between the model and view.

A source application is a computer program/software package derived from a source that performs specific functions for end-users and/or other applications. The MVC layer is built using source code, a set of instructions written in a programming language derived from the source. The systems and methods may include dynamic updating of a UI program based on changes in a container application interface (“AIT”).

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout.

FIG. 1 shows an illustrative process flow 100 for a system in accordance with principles of the disclosure.

FIG. 2 shows an illustrative process flow 200 for a system in accordance with principles of the disclosure.

FIG. 3 shows an illustrative process flow 300 for a system in accordance with principles of the disclosure.

FIG. 4 shows an illustrative process flow 400 for a system in accordance with principles of the disclosure.

FIG. 5 shows a schematic diagram 500 in accordance with principles of the disclosure.

FIG. 6 shows another schematic diagram 600 in accordance with principles of the disclosure.

### DETAILED DESCRIPTION OF THE DISCLOSURE

Systems and methods are provided for intelligently identifying changes to a cloud container setup. Systems and methods may include modifying a UI program with new connectors.

Containerization may be, e.g., a software deployment method operable to pack an application with dependencies, libraries, and configuration files into a single, lightweight unit called a container. Containers may be isolated from a host operating system but may share the host operating system kernel. This makes containers portable and efficient.

Containers may run consistently across numerous environments, e.g., on-premises, cloud, and/or hybrid platforms. Containers may be operable to solve compatibility issues common in traditional development methods. Containers may be faster and less resource-intensive than virtual machines. Containers may enable scalability, fault isolation, and efficient resource usage.

Intelligent dynamic updating may include changes in a distributed cloud environment. A source application may be, e.g., a baseline container. The baseline container may contain, e.g., all small business data on a high level (card data), card data formulation, and card data. The systems and methods may keep a copy of the updating in the baseline container. Multiple teams (e.g., reporting, analytics, etc.) may access and use the baseline container and the data within. A cloud setting may be public or private.

The systems and methods may recalibrate the system to get rid of anomalies and to bring stability to the UI/UX. The systems and methods may connect a plurality of cloud container applications to a UI. The systems and methods may automatically create a corrected/updated UI program. The systems and methods may upload the corrected/updated UI in a test environment. The systems and methods may replace a UI program with the updated UI program.

Systems for intelligent, dynamic updating of a UI/UX based on changes in cloud containerization setup are provided. The systems may include a server. The server may include a plurality of cloud container applications. The systems may include a UI. The UI may be operable to run the plurality of cloud container applications. The UI may be operable to run a UI program. The UI may be operable to run a source application. The source application may include an MVC layer.

The systems may include a DMCE. The systems may include an ML engine. The ML engine may be operable to run an ML program. The systems may be operable to scan, via the DMCE, the plurality of cloud container applications for a cloud containerization setup.

The systems may be operable to detect, via the ML program on the ML engine, an anomaly in the cloud containerization setup. The systems may be operable to trace, via the DMCE, the anomaly with the MVC layer of the source application.

The systems may be operable to identify, via the DMCE, one or more impacted connectors in the UI program. Impacted connectors are UI program components that have been affected by changes in the system, thereby causing functionality and/or performance issues. These impacted connectors may require attention and/or updating to ensure proper function within the UI program. The systems may be operable to modify, via the DMCE, the one or more impacted connectors in the UI program, thereby creating an updated UI program.

The systems may be operable to deploy, via the DMCE, the updated UI program in a test environment. The systems may be operable to validate, via the DMCE, the updated UI program in the plurality of cloud container applications. If the updated UI program causes instability in the UI/UX, the systems may be operable to be manually overridden, via the DMCE, by a user.

The systems may be operable to dynamically update, via the DMCE, the UI program based on changes in an AIT. The plurality of cloud container applications may include a plurality of cloud containers. The plurality of cloud containers may include a plurality of container configurations. The plurality of container configurations may include, e.g., cloud setup, container position, and time.

The systems may be operable to connect, via the DMCE, a baseline cloud container to a cloud container via a connector. The systems may be operable to dynamically identify, via the ML program on the ML engine, an anomaly in a cloud container setup in the plurality of cloud container applications and send feedback to the DMCE.

The systems may include a cloud database. The cloud database may include the plurality of cloud container applications. The cloud database may be operable to send the plurality of cloud container applications to a baseline container. The cloud database may be operable to send the plurality of cloud container applications to an updated container. The baseline container may be operable to send the plurality of cloud container applications and a plurality of cloud containers to the DMCE. The updated container may be operable to send the plurality of cloud container applications and a plurality of cloud containers to the DMCE.

The systems may be operable to trace, via the DMCE, anomalies to the UI program with the MVC layer of the source application. The systems may include a user interface baseline. The systems may include a user interface updated.

The systems may be operable to send, via the DMCE, the plurality of cloud container applications to the user interface baseline. The systems may be operable to send, via the DMCE, the plurality of cloud container applications to the user interface updated. The user interface baseline may be operable to execute in the user interface updated a function to set credentials. The user interface baseline may be operable to populate a list in the user interface updated. The list in the user interface updated may include, e.g., a name, a username, and a password.

The systems may include a recurrent neural network (“RNN”). The RNN may include a deep learning ML program. The deep learning ML program may be operable to scan a data message flow in the MVC layer. The deep learning ML program may be operable to sync with scanned cloud container setup images from the plurality of cloud container applications. The deep learning ML program may be operable to detect anomalies in the cloud container setups images from the plurality of cloud container applications.

Methods for intelligent, dynamic updating of a UI/UX based on changes in cloud containerization setup are provided. Methods may include scanning, via a DMCE, a plurality of cloud container applications for a cloud containerization setup. The plurality of cloud container applications may be operable to run on a UI. The UI may be operable to run the plurality of cloud container applications. The UI may be operable to run the UI program. The UI may be operable to run the source application. The source application may include an MVC layer.

Methods may include detecting, via an ML program on an ML engine, an anomaly in the cloud containerization setup. Methods may include tracing, via the DMCE, the anomaly with the MVC layer of the source application. Methods may include identifying, via the DMCE, one or more impacted connectors in the UI program. Methods may include modifying, via the DMCE, the one or more impacted connectors in the UI program, thereby creating an updated UI program. Methods may include deploying, via the DMCE, the updated UI program in a test environment. Methods may include validating, via the DMCE, the updated UI program in the plurality of cloud container applications. Methods may include, if the updated UI program causes instability in the UI/UX, manually overriding the DMCE by a user.

Methods may include dynamically updating the UI program based on changes in an AIT. Methods may include forwarding, via the DMCE, the plurality of cloud container applications to a plurality of AITs. The AITs may reduce instability caused by changes to the UI program from changes to the plurality of cloud container applications.

Methods may include using a plurality of cloud container applications. The plurality of cloud container applications may include a plurality of cloud containers. The plurality of cloud containers may include a plurality of container configurations. The plurality of container configurations may include, e.g., cloud setup, container position, and time.

Methods may include connecting, via the DMCE, a baseline cloud container to a cloud container via a connector. Methods may include dynamically identifying, via the ML program on the ML engine, an anomaly in a cloud container setup in the plurality of cloud container applications. Methods may include sending feedback to the DMCE.

Methods may include sending, via a cloud database comprising the plurality of cloud container applications, the plurality of cloud container applications to a baseline container. Methods may include sending, via a cloud database comprising the plurality of cloud container applications, the plurality of cloud container applications to an updated container. Methods may include sending, via the baseline container, the plurality of cloud container applications and a plurality of cloud containers to the DMCE. Methods may include sending, via the updated container, the plurality of cloud container applications and a plurality of cloud containers to the DMCE.

Methods may include tracing, via the DMCE, anomalies to the UI program with the MVC layer of the source application. Methods may include sending, via the DMCE, the plurality of cloud container applications to a user interface baseline. Methods may include sending, via the DMCE, the plurality of cloud container applications to a user interface updated. The user interface baseline may be operable to execute in the user interface updated a function to set credentials. The user interface baseline may be operable to populate a list in the user interface updated. The list may include, e.g., a name, a username, and a password.

Methods may include scanning, via a deep learning ML program on an RNN, a data message flow in the MVC layer. Methods may include syncing the UI program, via the deep learning ML program on the RNN, with scanned cloud container setup images from the plurality of cloud container applications. Methods may include detecting, via the deep learning ML program on the RNN, anomalies in the cloud container setups images from the plurality of cloud container applications.

Systems and methods described herein are illustrative. Systems and methods in accordance with this disclosure will now be described in connection with the figures, which form a part hereof. The figures show illustrative features of system and method steps in accordance with the principles of this disclosure. It is understood that other embodiments may be utilized, and that structural, functional, and procedural modifications may be made without departing from the scope and spirit of the present disclosure.

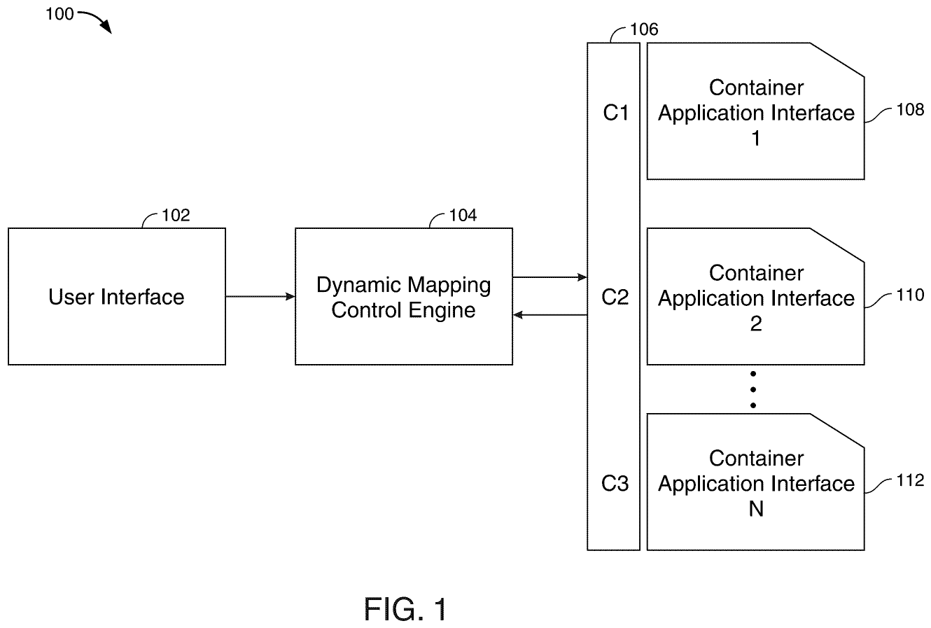

FIG. 1 shows an illustrative process flow 100 for a system in accordance with principles of the disclosure.

Illustrative process flow 100 may include a user interface (“UI”) 102. The UI 102 may send a plurality of cloud container applications to a dynamic mapping control engine (“DMCE”) 104. DMCE 104 may forward the plurality of cloud container applications to a plurality of container application interfaces (“AITs”) C1, C2, and C3, 106, (e.g., container application interface 1, 108, container application interface 2, 110, and container application interface 3, 112).

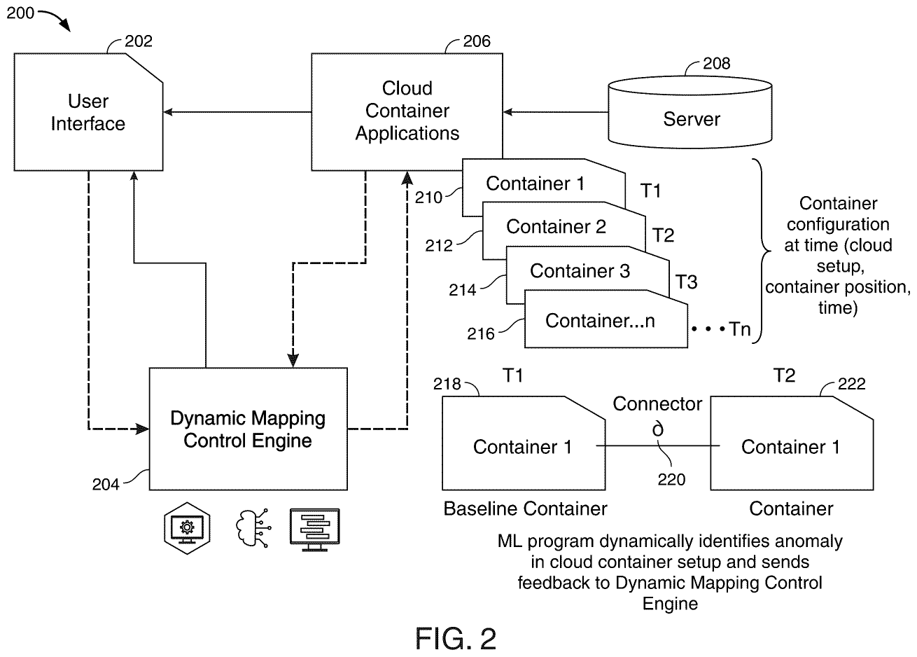

FIG. 2 shows an illustrative process flow 200 for a system in accordance with principles of the disclosure.

The illustrative process flow 200 may include a server 208. The server 208 may contain a plurality of cloud container applications 206. The plurality of cloud container applications 206 may contain, e.g., container 1, T1, 210, container 2, T2, 212, container 3, T3, 214, and container n, Tn, 216. The container configuration at any time may include, e.g., cloud setup, container position, and time. The plurality of cloud container applications 206 may be sent to a user interface (“UI”) 202.

UI 202 may send the plurality of cloud container applications 206 to a dynamic mapping control engine (“DMCE”) 204. The DMCE 204 may send the plurality of cloud container applications 206 back to the UI. The DMCE 204 may update the cloud container applications 206 and send the updated versions back to cloud container applications 206.

The illustrative process flow 200 may include a container 1, T1, baseline container 218 and a container 1, T2, container 222. Container 1, T1, baseline container 218 may be connected to container 1, T2, container 222 via connector 220. An ML program may dynamically identify an anomaly in a cloud container setup and send feedback to the DMCE.

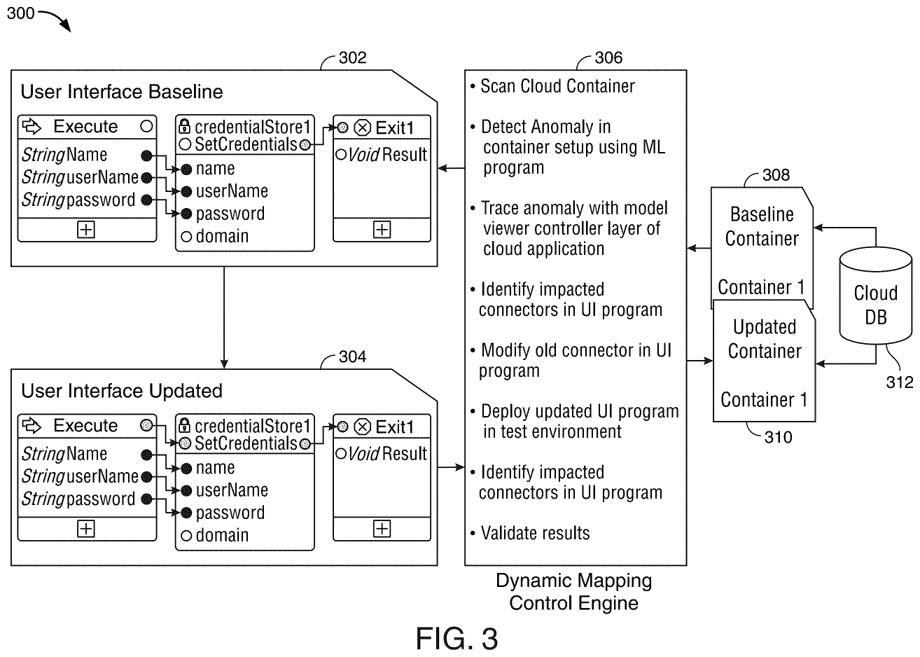

FIG. 3 shows an illustrative process flow 300 for a system in accordance with principles of the disclosure.

Illustrative process flow 300 may include a cloud database (“DB”) 312. The cloud DB 312 may contain a plurality of cloud container applications. The cloud DB 312 may send the plurality of cloud container applications to, e.g., baseline container, container 1, 308 and updated container, container 1, 310.

Baseline container, container 1, 308 and updated container, container 1, 310 may send the plurality of cloud container applications to a dynamic mapping control engine (“DMCE”) 306. The DMCE 306 may scan the plurality of cloud containers and cloud container applications. The DMCE 306 may detect anomalies in container setup using an ML program. The DMCE 306 may trace the anomalies with a MVC layer of a cloud container application. The DMCE 306 may identify any impacted connectors in the UI program. The DMCE 306 may modify impacted connectors in the UI program. DMCE 306 may deploy an updated UI program in a test environment. DMCE 306 may validate its results. The DMCE 306 may validate results by analyzing test results of the modified impacted connectors in the updated UI program in the test environment.

Illustrative process flow 300 may include user interface baseline 302 and user interface updated 304. The DMCE 306 may send the plurality of cloud container applications to the user interface baseline 302. The DMCE 306 may send the plurality of cloud container applications to the user interface updated 304.

The user interface baseline 302 may be executed in user interface updated to “SetCredentials” and populating “StringName,” “StringuserName,” and “Stringpassword” with “name,” “username,” and “password,” respectively.

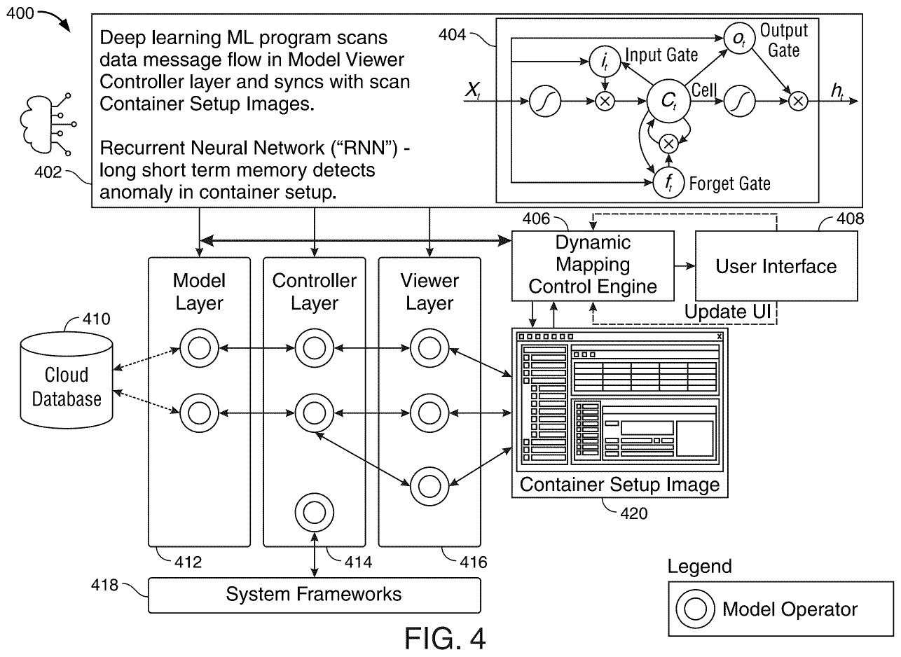

FIG. 4 shows an illustrative process flow 400 for a system in accordance with principles of the disclosure.

Illustrative process flow 400 may include recurrent neural network (“RNN”) 402. RNN 402 may include a deep learning ML program. The ML program may scan a data message flow in a MVC layer. The ML program may sync with scan container setup images. RNN 402 may include a long and/or short term memory. The long and/or short term memory may detect anomalies in container setups.

RNN 402 may include schematic 404. Schematic 404 may include the mechanism of RNN 402. Schematic 404 may include, e.g., an input (Xt), input gate (It), an output gate (Ot), a cell (Ct), a forget gate (Ft), and an output (Ht).

Illustrative process flow 400 may include cloud database 410. Cloud database 410 may contain a plurality of cloud container applications. Cloud database 410 may send the plurality of cloud container applications to a plurality of model operators within model layer 412. Model layer 412 may send the plurality of cloud container applications to a plurality of model operators within a controller layer 414.

Controller layer 414 may send the plurality of cloud container applications to a plurality of model operators within a viewer layer 416 and system frameworks 418. The viewer layer 416 may send the plurality of cloud container applications to a container setup image 420. The container setup image may be in two-way communication with a dynamic mapping control engine (“DMCE”).

The DMCE 406 may send the plurality of cloud container applications to a user interface (“UI”) 408. The UI may send the plurality of cloud container applications back to the DMCE 406. The DMCE 406 may update the UI program. The DMCE 406 may send the updated UI program to the UI 408.

RNN 402 may send a plurality of cloud container applications to the model layer 412, controller layer 414, and the viewer layer 416. RNN 402 may also send the plurality of cloud container applications to DMCE 406.

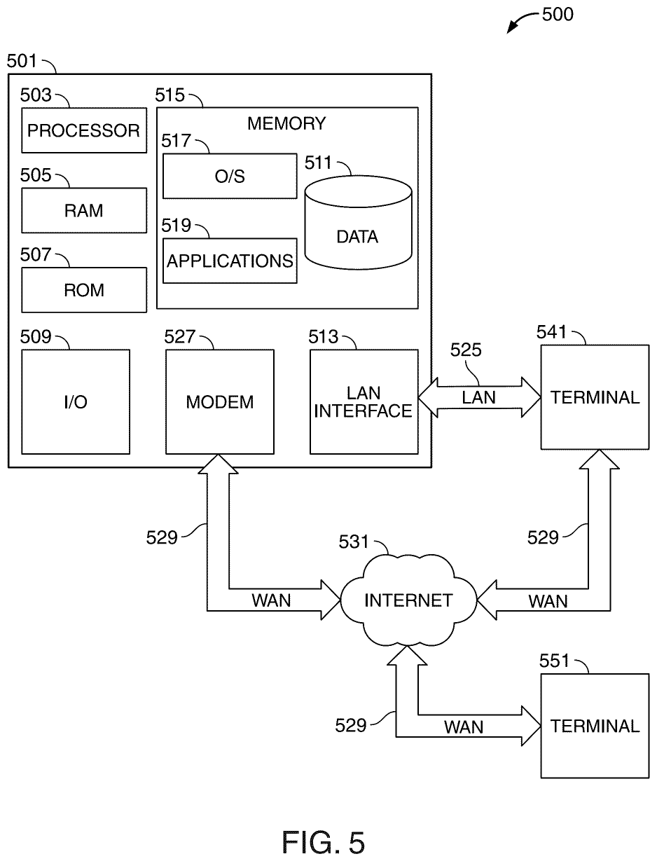

FIG. 5 shows an illustrative block diagram of system 500 that includes computer 501. Computer 501 may alternatively be referred to herein as an “engine,” “server,” or a “computing device.” Computer 501 may be a workstation, desktop, laptop, tablet, smartphone, or any other suitable computing device. Elements of system 500, including computer 501, may be used to implement various aspects of the systems and methods disclosed herein. Each of the systems, methods and algorithms illustrated below may include some or all of the elements and apparatus of system 500.

Computer 501 may include processor 503 for controlling the operation of the device and its associated components, and may include RAM 505, ROM 507, input/output (“I/O”) 509, and a non-transitory or non-volatile memory 515. Machine-readable memory may be configured to store information in machine-readable data structures. Processor 503 may also execute all software running on the computer. Other components commonly used for computers, such as electrically erasable programmable read-only memory (“EEPROM”) or flash memory or any other suitable components, may also be part of computer 501.

Memory 515 may include any suitable permanent storage technology, such as a hard drive. Memory 515 may store software including the operating system 517 and application program(s) 519 along with any data 511 needed for the operation of the system 500. Memory 515 may also store videos, text, and/or audio assistance files. The data stored in memory 515 may also be stored in cache memory, or any other suitable memory.

I/O module 509 may include connectivity to a microphone, keyboard, touch screen, mouse, and/or stylus through which input may be provided into computer 501. The input may include input relating to cursor movement. The input/output module may also include one or more speakers for providing audio output and a video display device for providing textual, audio, audiovisual, and/or graphical output. The input and output may be related to computer application functionality.

System 500 may be connected to other systems via a local area network (“LAN”) interface 513. System 500 may operate in a networked environment supporting connections to one or more remote computers, such as terminals 541 and 551. Terminals 541 and 551 may be personal computers or servers that include many or all of the elements described above relative to system 500. The network connections depicted in FIG. 5 include a LAN 525 and a wide area network (“WAN”) 529 but may also include other networks. When used in a LAN networking environment, computer 501 may connect to LAN 525 through LAN interface 513 or an adapter. When used in a WAN networking environment, computer 501 may include modem 527 or other means for establishing communications over WAN 529, such as Internet 531.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 519, which may be used by computer 501, may include computer executable instructions for invoking functionality related to communication, such as e-mail, Short Message Service (“SMS”), and voice input and speech recognition applications. Application program(s) 519 (which may be alternatively referred to herein as “plugins,” “applications,” or “apps”) may include computer executable instructions for invoking functionality related to performing various tasks. Application program(s) 519 may utilize one or more algorithms that process received executable instructions, perform power management routines or other suitable tasks.

The invention may be described in the context of computer-executable instructions, such as application(s) 519, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 501 and/or terminals 541 and 551 may also include various other components, such as a battery, speaker, and/or antennas (not shown). Components of computer system 501 may be linked by a system bus, wirelessly or by other suitable interconnections. Components of computer system 501 may be present on one or more circuit boards. In some embodiments, the components may be integrated into a single chip. The chip may be silicon-based.

Terminal 541 and/or terminal 551 may be portable devices such as a laptop, cell phone, tablet, smartphone, or any other computing system for receiving, storing, transmitting and/or displaying relevant information. Terminal 541 and/or terminal 551 may be one or more user devices. Terminals 541 and 551 may be identical to system 500 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

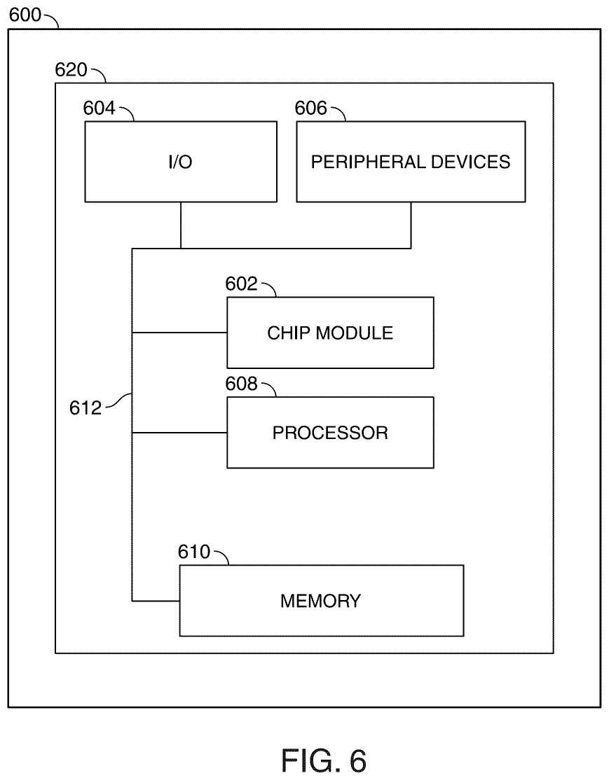

FIG. 6 shows illustrative apparatus 600 that may be configured in accordance with the principles of the disclosure. Apparatus 600 may be a computing device. Apparatus 600 may include one or more features of the apparatus shown in FIG. 5. Apparatus 600 may include chip module 602, which may include one or more integrated circuits, and which may include logic configured to perform any suitable logical operations.

Apparatus 600 may include one or more of the following components: I/O circuitry 604, which may include a transmitter device and a receiver device and may interface with fiber optic cable, coaxial cable, telephone lines, wireless devices, PHY layer hardware, a keypad/display control device or any other suitable media or devices; peripheral devices 606, which may include counter timers, real-time timers, power-on reset generators or any other suitable peripheral devices; logical processing device 608, which may compute data structural information and structural parameters of the data; and machine-readable memory 610.

Machine-readable memory 610 may be configured to store in machine-readable data structures: machine executable instructions, (which may be alternatively referred to herein as “computer instructions” or “computer code”), applications such as applications 619, signals, and/or any other suitable information or data structures.

Components 602, 604, 606, 608, and 610 may be coupled together by a system bus or other interconnections 612 and may be present on one or more circuit boards such as circuit board 620. In some embodiments, the components may be integrated into a single chip. The chip may be silicon-based.

The disclosure may be operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc., that perform tasks or implement abstract data types. The disclosure may also be practiced in distributed computing environments where tasks are performed by remote processing devices that are linked through a communications network. In a distributed computing environment, program modules may be in both local and remote computer storage media including memory storage devices.

The steps of methods and systems may be performed in orders beyond the order shown and/or described herein. Embodiments may omit steps shown and/or described in connection with illustrative methods. Embodiments may include steps that are neither shown nor described in connection with illustrative methods.

Illustrative methods and systems steps may be combined. For example, an illustrative method may include steps shown in connection with another illustrative method.

Methods and systems may omit features shown and/or described in connection with illustrative methods and systems. Embodiments may include features that are neither shown nor described in connection with the illustrative methods and systems. Features of illustrative methods and systems may be combined. For example, an illustrative embodiment may include features shown in connection with another illustrative embodiment.

The drawings show illustrative features of methods and systems in accordance with the principles of the disclosure. The features are illustrated in the context of selected embodiments. It will be understood that features shown in connection with one of the embodiments may be practiced in accordance with the principles of the disclosure along with features shown in connection with another of the embodiments.

One of ordinary skill in the art will appreciate that the steps shown and described herein may be performed in other ways and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, AI systems and methods for safeguarding output with respect to decisioning which queries qualify for an adaptive feedback loop are provided. Persons skilled in the art will appreciate that the present disclosure can be practiced in other ways. The described embodiments are presented for purposes of illustration—not limitation—and the present disclosure is limited only by the claims that follow.

What is claimed is:

1. A system for intelligent, dynamic updating of a user interface/user experience (“UI/UX”) based on changes in cloud containerization setup, the system comprising:
a server, the server comprising a plurality of cloud container applications;
a user interface (“UI”), the UI operable to run the plurality of cloud container applications, a UI program, and a source application, the source application comprising a model-viewer-controller (“MVC”) layer;
a dynamic mapping control engine (“DMCE”); and
a machine learning (“ML”) engine, the ML engine operable to run an ML program;
the system operable to:
scan, via the DMCE, the plurality of cloud container applications for a cloud containerization setup;
detect, via the ML program on the ML engine, an anomaly in the cloud containerization setup;
trace, via the DMCE, the anomaly with the MVC layer of the source application;
identify, via the DMCE, one or more impacted connectors in the UI program;
modify, via the DMCE, the one or more impacted connectors in the UI program, thereby creating an updated UI program;
deploy, via the DMCE, the updated UI program in a test environment; and
validate, via the DMCE, the updated UI program in the plurality of cloud container applications;
wherein, if the updated UI program causes instability in the UI/UX, the system is further operable to be manually overridden, via the DMCE, by a user.

2. The system of claim 1, wherein the system is further operable to dynamically update, via the DMCE, the UI program based on changes in a container application interface (“AIT”).

3. The system of claim 1, wherein the system is further operable to forward, via the DMCE, the plurality of cloud container applications to a plurality of AITs, the AITs operable to reduce instability caused by changes to the UI program from changes to the plurality of cloud container applications.

4. The system of claim 1, wherein the plurality of cloud container applications comprises a plurality of cloud containers, the plurality of cloud containers comprises a plurality of container configurations, and the plurality of container configurations comprises cloud setup, container position, and time.

5. The system of claim 1, wherein the system is further operable to connect, via the DMCE, a baseline cloud container to a cloud container via a connector.

6. The system of claim 1, wherein the system is further operable to dynamically identify, via the ML program on the ML engine, an anomaly in a cloud container setup in the plurality of cloud container applications and send feedback to the DMCE.

7. The system of claim 1, the system further comprising a cloud database, the cloud database comprising the plurality of cloud container applications, the cloud database operable to send the plurality of cloud container applications to a baseline container and an updated container, and the baseline container and the updated container operable to send the plurality of cloud container applications and a plurality of cloud containers to the DMCE.

8. The system of claim 1, wherein the system is further operable to trace, via the DMCE, anomalies to the UI program with the MVC layer of the source application.

9. The system of claim 1, the system further comprising a user interface baseline and a user interface updated, the system further operable to send, via the DMCE, the plurality of cloud container applications to the user interface baseline and the user interface updated, the user interface baseline operable to execute in the user interface updated a function to set credentials, and to populate a list in the user interface updated comprising a name, a username, and a password.

10. The system of claim 1, the system further comprising a recurrent neural network (“RNN”), the RNN comprising a deep learning ML program, the deep learning ML program operable to scan a data message flow in the MVC layer, sync with scanned cloud container setup images from the plurality of cloud container applications, and detect anomalies in the cloud container setups images from the plurality of cloud container applications.

11. A method for intelligent, dynamic updating of a user interface/user experience (“UI/UX”) based on changes in cloud containerization setup, the method comprising:
scanning, via a dynamic mapping control engine (“DMCE”), a plurality of cloud container applications for a cloud containerization setup, the plurality of cloud container applications operable to run on a user interface (“UI”), the UI operable to run the plurality of cloud container applications, a UI program, and a source application, the source application comprising a model-viewer-controller (“MVC”) layer;
detecting, via a machine learning (“ML”) program on an ML engine, an anomaly in the cloud containerization setup;
tracing, via the DMCE, the anomaly with the MVC layer of the source application;
identifying, via the DMCE, one or more impacted connectors in the UI program;
modifying, via the DMCE, the one or more impacted connectors in the UI program, thereby creating an updated UI program;
deploying, via the DMCE, the updated UI program in a test environment; and
validating, via the DMCE, the updated UI program in the plurality of cloud container applications;
wherein, if the updated UI program causes instability in the UI/UX, the method further comprises manually overriding the DMCE by a user.

12. The method of claim 11, wherein the method further comprises dynamically updating the UI program based on changes in a container application interface (“AIT”).

13. The method of claim 11, wherein the method further comprises forwarding, via the DMCE, the plurality of cloud container applications to a plurality of AITs, the AITs reducing instability caused by changes to the UI program from changes to the plurality of cloud container applications.

14. The method of claim 11, wherein the plurality of cloud container applications comprises a plurality of cloud containers, the plurality of cloud containers comprises a plurality of container configurations, and the plurality of container configurations comprises cloud setup, container position, and time.

15. The method of claim 11, wherein the method further comprises connecting, via the DMCE, a baseline cloud container to a cloud container via a connector.

16. The method of claim 11, wherein the method further comprises dynamically identifying, via the ML program on the ML engine, an anomaly in a cloud container setup in the plurality of cloud container applications and send feedback to the DMCE.

17. The method of claim 11, wherein the method further comprises:
sending, via a cloud database comprising the plurality of cloud container applications, the plurality of cloud container applications to a baseline container and an updated container; and
sending, via the baseline container and the updated container, the plurality of cloud container applications and a plurality of cloud containers to the DMCE.

18. The method of claim 11, wherein the method further comprises tracing, via the DMCE, anomalies to the UI program with the MVC layer of the source application.

19. The method of claim 11, wherein the method further comprises sending, via the DMCE, the plurality of cloud container applications to a user interface baseline and a user interface updated, the user interface baseline operable to execute in the user interface updated a function to set credentials, and to populate a list in the user interface updated comprising a name, a username, and a password.

20. The method of claim 11, wherein the method further comprises:
scanning, via a deep learning ML program on a recurrent neural network (“RNN”), a data message flow in the MVC layer;
syncing the UI program, via the deep learning ML program on the RNN, with scanned cloud container setup images from the plurality of cloud container applications; and
detecting, via the deep learning ML program on the RNN, anomalies in the cloud container setups images from the plurality of cloud container applications.
